(19) United States
(12) Patent Application Publication
(10) Pub. No.: US 2006/0037439 A1
(43) Pub. Date: Feb. 23, 2006

(54) Hammer having vibration absorbing effect

(76) Inventor: John Chen, Taichung County (TW)

Correspondence Address: CHARLES E. BAXLEY, ESQ., 90 JOHN STREET, THIRD FLOOR, NEW YORK, NY, 10038, US

(21) Appl. No.: 10/921,541

(22) Filed: Aug. 19, 2004

(51) Int. Cl. B25D 1/12

(52) U.S. Cl. 81/22

(57) ABSTRACT

A hammer includes a handle, a head mounted on the handle and having a distal end having an end face formed with an insertion recess, and a striking portion mounted on the distal end of the head and having an end face formed with an insertion block inserted into the insertion recess of the head. Thus, the cushioning gap between the striking portion and the head provides a vibration absorbing and cushioning effect during operation of the hammer, so that the hammer is operated smoothly and stably, thereby enhancing the striking effect of the hammer, and thereby facilitating a user operating the hammer.

### BACKGROUND OF THE INVENTION

1. Field of the Invention

The present invention relates to a hammer, and more particularly to a hammer having a vibration absorbing and cushioning effect.

2. Description of the Related Art

A conventional hammer in accordance with the prior art shown in FIG. 5 comprises a handle 10, a head 15 integrally formed on a first end of the handle 10, a striking portion 16 integrally formed on a distal end of the head 15, and a grip 11 mounted on a second end of the handle 10. However, when the striking portion 16 of the hammer hits a workpiece, such as the nail or the like, the vibration applied on the striking portion 16 is directly transmitted through the head 15 and the handle 10 to a user's hand, so that the user easily feels uncomfortable, thereby causing inconvenience to the user during operation of the hammer. In addition, the striking portion 16, the head 15 and the handle 10 are formed integrally to form the hammer, so that the whole hammer needs to be worked by a solidifying treatment, thereby increasing costs of fabrication.

### SUMMARY OF THE INVENTION

The present invention is to mitigate and/or obviate the disadvantage of the conventional hammer.

The primary objective of the present invention is to provide a hammer having a vibration absorbing and cushioning effect.

Another objective of the present invention is to provide a hammer, wherein the cushioning gap between the striking portion and the head provides a vibration absorbing and cushioning effect during operation of the hammer, so that the hammer is operated smoothly and stably, thereby enhancing the striking effect of the hammer, and thereby facilitating a user operating the hammer.

A further objective of the present invention is to provide a hammer, wherein the hammer provides a cushioning effect, thereby preventing the user's hand from being hurt seriously due to slip of the hammer so as to enhance the safety of use.

A further objective of the present invention is to provide a hammer, wherein the striking portion and the head are made individually without needing a working process of solidifying treatment, thereby decreasing costs of fabrication.

In accordance with the present invention, there is provided a hammer, comprising:

a handle;

a head mounted on a first end of the handle and having a distal end having an end face formed with an insertion recess; and

a striking portion mounted on the distal end of the head and having an end face formed with an insertion block inserted into the insertion recess of the head.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hammer in accordance with the preferred embodiment of the present invention;

FIG. 2 is an exploded perspective view of the hammer as shown in FIG. 1;

FIG. 3 is a partially plan cross-sectional view of the hammer as shown in FIG. 1;

FIG. 4 is a partially enlarged view of the hammer as shown in FIG. 3; and

FIG. 5 is a perspective view of a conventional hammer in accordance with the prior art.

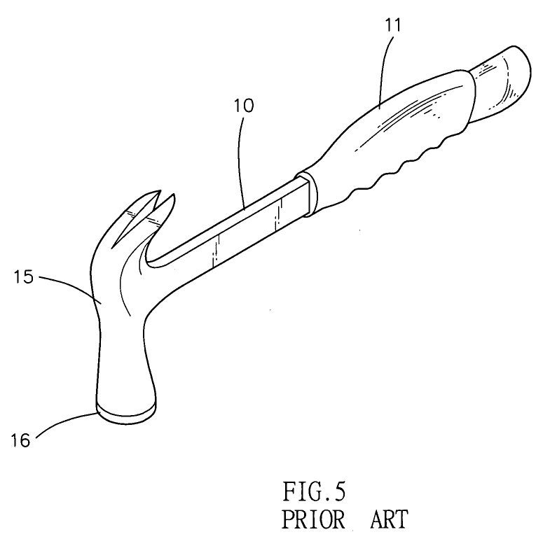

### DETAILED DESCRIPTION OF THE INVENTION

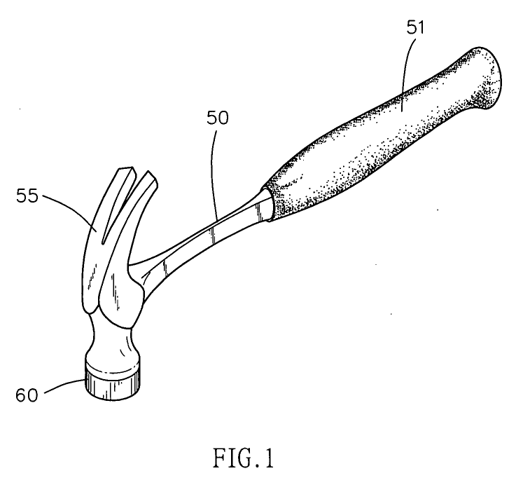

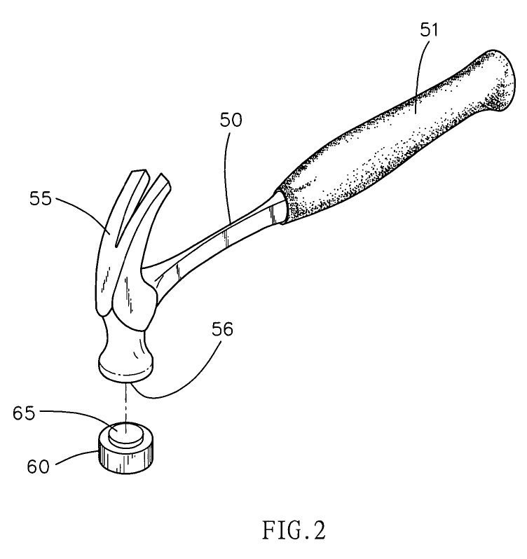

Referring to the drawings and initially to FIGS. 1 and 2, a hammer in accordance with the preferred embodiment of the present invention comprises a handle 50, a head 55 mounted on a first end of the handle 50, a striking portion 60 mounted on a distal end of the head 55, and a grip 51 mounted on a second end of the handle 50.

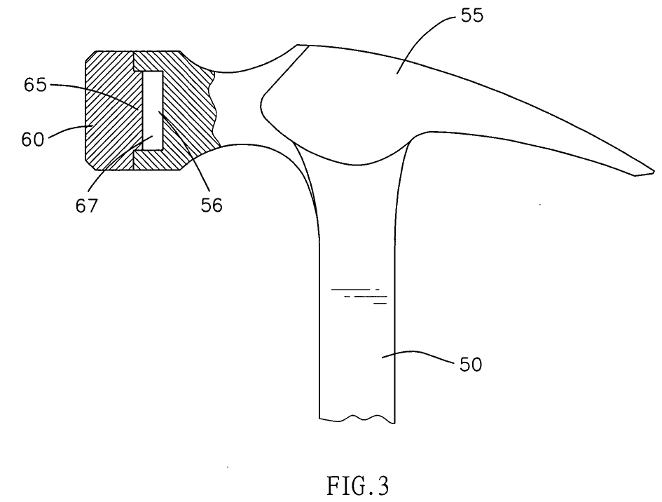

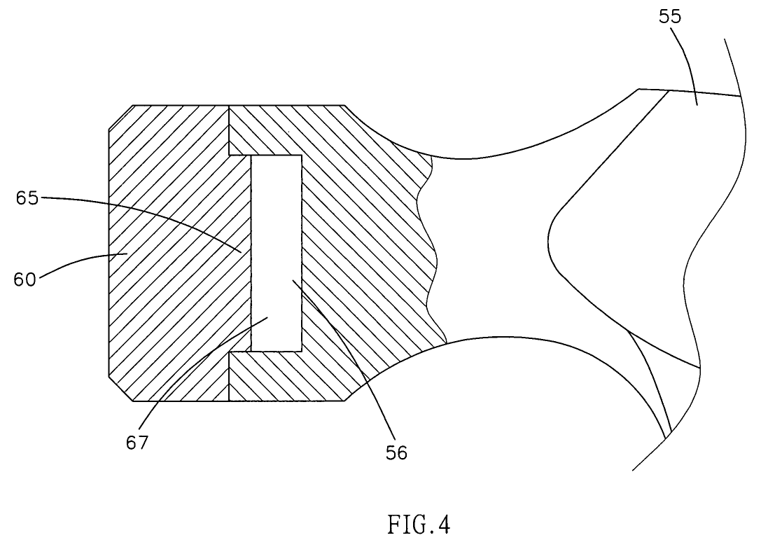

Referring to FIGS. 1-4, the distal end of the head 55 has an end face formed with an insertion recess 56. Preferably, the insertion recess 56 of the head 55 has a circular shape. The striking portion 60 is separated from the head 55 and has an end face formed with an insertion block 65 inserted into the insertion recess 56 of the head 55. Preferably, the insertion block 65 of the striking portion 60 has a circular shape and has a diameter greater than that of the insertion recess 56 of the head 55, so that the insertion block 65 of the striking portion 60 is forced into the insertion recess 56 of the head 55 in a close fit manner. In addition, the insertion block 65 of the striking portion 60 has a thickness smaller than a depth of the insertion recess 56 of the head 55, so that a cushioning gap 67 is formed between the insertion block 65 of the striking portion 60 and the insertion recess 56 of the head 55 to provide a vibration absorbing and cushioning effect during operation of the hammer.

Accordingly, the cushioning gap 67 between the striking portion 60 and the head 55 provides a vibration absorbing and cushioning effect during operation of the hammer, so that the hammer is operated smoothly and stably, thereby enhancing the striking effect of the hammer, and thereby facilitating a user operating the hammer. In addition, the hammer provides a cushioning effect, thereby preventing the user's hand from being hurt seriously due to slip of the hammer so as to enhance the safety of use. Further, the striking portion 60 and the head 55 are made individually without needing a working process of solidifying treatment, thereby decreasing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A hammer, comprising:
a handle;
a head mounted on a first end of the handle and having a distal end having an end face formed with an insertion recess; and
a striking portion mounted on the distal end of the head and having an end face formed with an insertion block inserted into the insertion recess of the head.

2. The hammer in accordance with claim 1, wherein the striking portion is separated from the head.

3. The hammer in accordance with claim 1, wherein the insertion recess of the head has a circular shape.

4. The hammer in accordance with claim 1, wherein the insertion block of the striking portion has a circular shape.

5. The hammer in accordance with claim 1, wherein the insertion block of the striking portion and has a diameter greater than that of the insertion recess of the head.

6. The hammer in accordance with claim 1, wherein the insertion block of the striking portion has a thickness smaller than a depth of the insertion recess of the head, so that a cushioning gap is formed between the insertion block of the striking portion and the insertion recess of the head.

7. The hammer in accordance with claim 1, further comprising a grip mounted on a second end of the handle.
